(19) United States
(12) Patent Application Publication
(10) Pub. No.: US 2013/0189387 A1
(43) Pub. Date: Jul. 25, 2013

(54) TEXTURED RELEASE LINER CONTAINING AN ORGANIC PARTICULATE PHASE

(71) Applicant: David J. Bravet, Westborough, MA (US)

(72) Inventor: David J. Bravet, Westborough, MA (US)

(21) Appl. No.: 13/733,124

(22) Filed: Jan. 2, 2013

Related U.S. Application Data
(60) Provisional application No. 61/584,306, filed on Jan. 8, 2012.

(51) Int. Cl. B29C 47/00; C08L 27/18

(52) U.S. Cl. CPC B29C 47/00; C08L 27/18
USPC 425/89; 525/199; 525/200

(57) ABSTRACT

A release liner can include one or more release layers. The release layer can include a thermoplastic polymer matrix. Moreover, the release layer can include an organic particulate phase. The organic particulate phase can be dispersed in the thermoplastic polymer matrix. In one embodiment, the organic particulate can include micronized PTFE particles. The PTFE particles can be present in the release liner such that the surface roughness Sₐ of the release liner ranges from 0.1 microns to 1 micron.

### CROSS-REFERENCE TO RELATED APPLICATION(S)

The present application claims priority from U.S. Provisional Patent Application No. 61/584,306, filed Jan. 8, 2012, entitled “TEXTURED RELEASE LINER CONTAINING AN ORGANIC PARTICULATE PHASE,” naming inventor David J. Bravet, which application is incorporated by reference herein in its entirety.

### FIELD OF THE DISCLOSURE

The present disclosure generally relates to a release liner and application of release liner in molding processes.

### BACKGROUND

Release films are used in the manufacture of composite parts as consumable products. Commonly, the release film acts as a physical barrier between the part to be molded and the vacuum bagging components used in the autoclave process. The release film prevents bleeding of the thermoset resins during curing and also provides easy removal of the vacuum bagging components.

Furthermore, release films are used as a physical barrier enabling demolding of cured composite parts after a curing cycle. In addition to a release function, it is desirable for the film article to improve post cured finishing operation such as ability to paint. It is also desirable for the release film to facilitate the evacuation of gaseous species such as air or any gas bubble generated during the curing process.

Moreover, release films are positioned on a vacuum table comprising multiple vacuum cells. The films are held in place by vacuum during manufacture process. Thereby, detrimental wrinkles or folds can be formed on the release film which could alter the surface of the composite after curing.

For at least the forgoing reasons, there is a need for release films having properties that address these detriments.

### SUMMARY

In a first aspect, a release liner can include one or more release layers. The release layer can include a thermoplastic polymer matrix. Moreover, the release layer can include an organic particulate phase. The organic particulate phase can be dispersed in the thermoplastic polymer matrix.

In a second aspect, a mold assembly can include a cavity for receiving a workpiece. A release liner can be disposed in the cavity. The release layer can include a thermoplastic polymer matrix. Moreover, the release layer can include an organic particulate phase. The organic particulate phase can be dispersed in the thermoplastic polymer matrix.

In a third aspect, a method of molding an article can include providing a mold assembly. The mold assembly can have an internal surface. The internal surface can define at least a portion of a cavity. The method can further include disposing a molding material into the cavity. The molding material can be disposed in the cavity, such that a release liner is positioned between the internal surface of the mold assembly and the molding material. The release layer can include a thermoplastic polymer matrix. Moreover, the release layer can include an organic particulate phase. The organic particulate phase can be dispersed in the thermoplastic polymer matrix. The method can further include curing the molding material to form a shaped article.

### BRIEF DESCRIPTION OF THE DRAWINGS

The present disclosure may be better understood, and its numerous features and advantages made apparent to those skilled in the art by referencing the accompanying drawings.

FIG. 1 shows a cross section of an exemplary single layered release liner according to aspects of the present disclosure.

FIGS. 2 and 3 show a cross section of exemplary multi-layered release liners according to aspects of the present disclosure.

The use of the same reference symbols in different drawings indicates similar or identical items.

### DETAILED DESCRIPTION

In an embodiment, a release liner can be used as a temporary assembly aid during molding processes and placed between a mold assembly and a work piece, such as molding material, which is formed into a shaped article during the molding process. The release liner can maintain its release properties across a broad temperature range, including operation temperatures during the curing phase of the molding process. Moreover, the release liner can maintain a textured appearance without affecting the surface of the shaped article. Thus, the release liner is free-standing and has no or substantially no adhesiveness before, during and after the molding process. As a free-standing means layered material, a release liner can be free of a supporting substrate. The release liner can have sufficient structural integrity to be handled in molding operations. In instances, the release liner can function to support workpieces during movement from one workstation to another.

In embodiments, a release liner can be an extruded article. While “extruded” refers to a processing pathway to form the release layer, it also can be identified that a layered material is extruded post fabrication. An extruded layer has detectable artifacts. For example, extruded layers can contain minute streaks. Moreover, transparent extruded material can be identified by changes in optical properties, such as refractive indices. Such changes can be measured and plotted along a length of a layer, the length being parallel to the extrusion direction. Moreover, such changes in optical properties can be measured along the width of a layer, the width being orthogonal to the extrusion direction. Yet in other instances, release liners that contain a particulate phase can be identified as extruded by analyzing an orientation of the particles compiling the particulate phase. Microscopic analysis can show particles having a similar orientation, wherein the larger faces of the particles are substantially parallel to the extrusion direction. Moreover, similar shaped particles can have substantially the same orientation in an extruded liner.

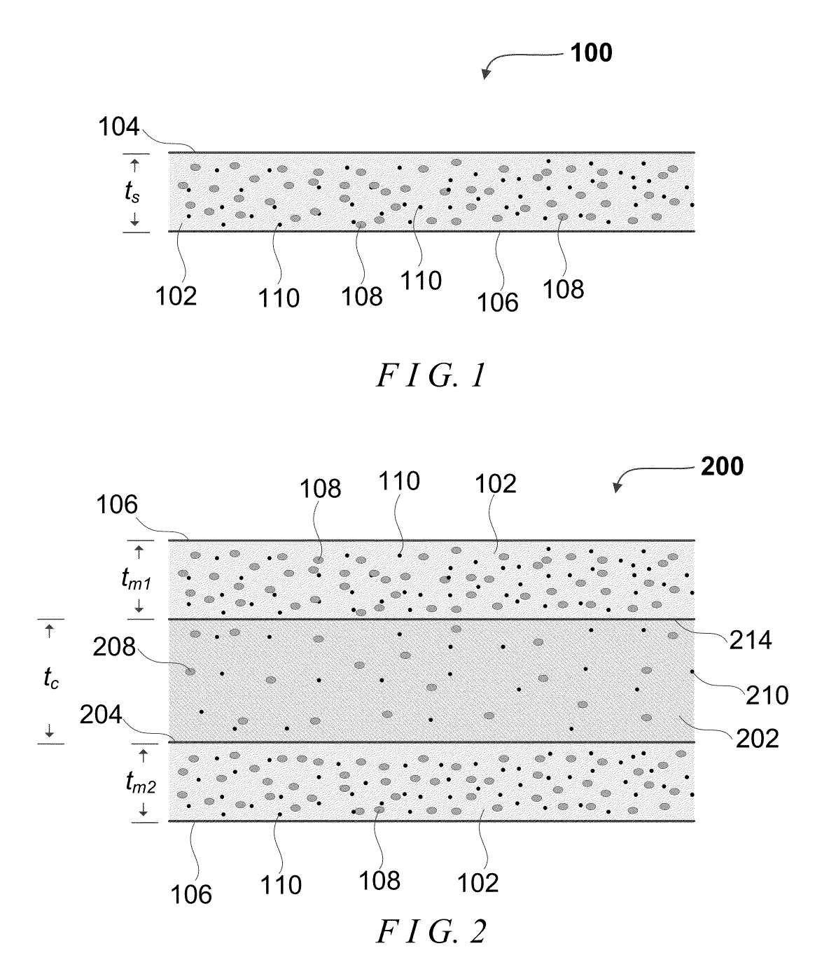

FIG. 1 illustrates a cross-sectional view of an exemplary release liner 100. The release liner 100 can include a thermoplastic polymer matrix 102. The thermoplastic polymer matrix 102 can have major surfaces 104 and 106. Further, the release liner 100 can include an organic particulate 108 dispersed in the polymer matrix 102. The release liner 100 can further include an inorganic filler 110 also dispersed in the thermoplastic polymer matrix 102. Although not illustrated FIG. 1, the release liner 100 can further include other layers overlying major surfaces 104 or 106. The other layers can include a thermoplastic polymer matrix, an organic particulate phase, or an inorganic filler. Examples of a multilayered release liner are further disclosed herein.

The thermoplastic polymer matrix 102 can include a melt-processible polymer. In embodiments, the thermoplastic polymer matrix 102 can include a fluoropolymer. In embodiments, the fluoropolymer can include a poly(ethylene-tetrafluoroethylene) (ETFE), a tetrafluoroethylene-perfluoropropylene (FEP), a perfluoroalkoxy (PFA), a polyethylenechlorotrifluoroethylene (ECTFE), a polyvinylidene fluoride (PVDF), and any combination thereof. In another embodiment, the fluoropolymer can be selected from a group comprising a poly(ethylene-tetrafluoroethylene) (ETFE), a tetrafluoroethylene-perfluoropropylene (FEP), a polyethylenechlorotrifluoroethylene (ECTFE), and any combination thereof. In another embodiment, the fluoropolymer can include a poly(ethylene-tetrafluoroethylene) (ETFE), a polyethylenechlorotrifluoroethylene (ECTFE), and any combination thereof. In one particular embodiment, the fluoropolymer includes a poly(ethylene-tetrafluoroethylene) (ETFE). In another embodiment, the fluoropolymer consists essentially of a poly(ethylene-tetrafluoroethylene) (ETFE).

In other instances, the fluoropolymer can include melt-processible fluoropolymers having melting points higher than temperatures applied to composites during molding manufacturing process. For example, some molding processes include an autoclave step subjecting a composite to 190° C. Thus, in embodiments, the thermoplastic polymer matrix 100 can have a melting point of at least about 195° C., such as at least about 200° C., at least about 205° C., or at least about 210° C. Moreover, the thermoplastic matrix should be melt-processible without affecting function, structure, or properties of other ingredients or elements of the release liner. Thus, in other embodiments, the melting point can be no greater than about 330° C., such as not greater than about 310° C., not greater than about 290° C., or not greater than about 270° C. It will be appreciated that the thermoplastic matrix can have a melting point within a range between any of the minimum and maximum values noted above.

For single-layered release liner as illustrated in FIG. 1, the release layer can have a thickness tₛ. In some embodiments, the release layer can have a thickness tₛ of at least about 5 microns, such as at least about 10 microns, at least about 15 microns, at least about 20 microns, at least about 25 microns, at least about 30 microns, or at least about 35 microns. In other embodiments, the release layer can have a thickness tₛ of no greater than about 500 microns, such as not greater than about 400 microns, not greater than about 350 microns, not greater than about 300 microns, not greater than about 250 microns, not greater than about 200 microns, not greater than about 150 microns, not greater than about 100 microns, not greater than about 80 microns or not greater than about 50 microns. It will be appreciated that the release layer can have a thickness tₛ within a range between any of the minimum and maximum values noted above.

The organic particulate 108 forms an organic particulate phase in the release liner 100. The organic particulate 108 can a non-melt-processible polymer. The non-melt-processible polymer remains solid during an extrusion manufacturing process of the release liner. In embodiments, the non-melt-processible polymer can include a polytetrafluoroethylene (PTFE). For example, the organic particulate phase can include PTFE particles. In instances, the PTFE particles can include sintered PTFE particles. Sintered PTFE particles can be thermally treated PTFE particles. The thermal treatment improves the integrity of the particles and minimizes or substantially eliminates interactions across the interface of the particle and the surrounding medium such as the thermoplastic polymer matrix 102. In instances, the PTFE particles can be micronized PTFE particles. Micronized particles can include PTFE particles manufactured to an average particle size in the single digit micron range. In embodiments, the organic particulate phase can include particles having an average particle size of at least about 1 micron, such as at least about 2 microns, at least about 3 microns, at least about 4 microns, or at least about 3 microns. In other embodiments, the average particle size of the organic particulates can be no greater than about 250 microns, such as not greater than about 200 microns, not greater than about 100 microns, not greater than about 50 microns, not greater than about 40 microns, not greater than about 30 microns, not greater than about 25 microns, or not greater than about 20 microns. It will be appreciated that the organic particulate can have particles with an average particle size within a range between any of the minimum and maximum values noted above.

Moreover, the organic particulate phase can include a plurality of particles 108 distributed in a bimodal distribution in the thermoplastic polymer matrix 102. In instances, the plurality of particles can have a first mode of the bimodal distribution, wherein the first mode can have an average particle size maximum of at least about 1 micron, such as at least about 2 microns, or at least about 3 microns and not greater than about 10 microns. In other instances, the plurality of particles can have a second mode of the bimodal distribution, wherein the second mode can have an average particle size maximum of at least about 10 micron, such as at least about 11 microns, or at least about 12 microns and not greater than about 30 microns. In one particular embodiment, the organic particulate phase can have a bimodal distribution of a plurality of organic particles 108, wherein the first mode can have an average particle size maximum between 2 microns and 5 microns, and a second mode can have an average particle size maximum between 10 microns and 25 microns.

The organic particulate phase including organic particles 108 affect the texturing of the surfaces 104 and 106 of the release liner 100. Texturing the surfaces 104 and 106 can improve the release properties of the release liner from a workpiece or a shaped article. In instances, the organic particulate phase changes surface properties, such as surface roughness Rₐ or areal surface roughness Sₐ of surfaces 104 and 106. The areal surface roughness Sₐ is an arithmetical mean height of the surface. In instances, the release liner 100 can have a surface roughness Sₐ of at least about 0.2 microns, such as at least about 0.3 microns, or at least about 0.4 microns. In other instances, the release liner 100 can have a surface roughness Sₐ of no greater than about 2.0 microns, such as not greater than about 1.8 microns, or not greater than about 1.5 microns. It will be appreciated that the release liner 100 can have a surface roughness Sₐ within a range between any of the minimum and maximum values noted above.

The organic particulate phase comprising organic particles 108 and the thermoplastic polymer matrix 102 can have a weight ratio of at least about 2:98, at least about 2:95, such as at least about 5:90, at least about 6:92, at least about 6:83, at least about 8:92, at least about 8:83, at least about 10:92, at least about 10:83, at least about 10:80, at least about 12:92, or at least about 12:83. In other embodiments, the weight ratio between the organic particulate phase and the thermoplastic polymer matrix can be no greater than about 20:78, such as not greater than about 15:83, not greater than about 15:92, not greater, or not greater than about 12:80. It will be appreciated that the weight ratio between the organic particulate phase and the thermoplastic polymer matrix can have a weight ratio within a range between any of the minimum and maximum values noted above.

In another embodiment, the particles 108 of the organic particulate phase can be present in an amount of at least about 1 wt %, such as at least about 2 wt %, at least about 3 wt %, at least about 5 wt %, at least about 7 wt %, at least about 8 wt %, at least about 10 wt %, at least about 12 wt %, or at least about 14 wt % relative to the weight of the release layer comprising the thermoplastic polymer 102. In yet another embodiment, the particles 108 of the organic particulate phase can be present in an amount no greater than about 25 wt %, such as not greater than about 23 wt %, not greater than about 20 wt %, not greater than about 18 wt %, not greater than about 16 wt %, or not greater than about 15 wt % relative to the weight of the release layer comprising the thermoplastic polymer 102.

The release liner 100 can further include an inorganic filler 110 dispersed in the thermoplastic polymer matrix 102. The inorganic filler can include titanium dioxide, calcium carbonate, zinc oxide, zinc sulfide, barium sulfate, and any combination thereof. In embodiments, the inorganic filler can have an average particle size of at least about 0.1 microns, such as about 0.2 microns, at least about 0.5 microns, at least about 1 micron, at least about 1.5 microns, or at least about 2 microns. In other embodiments, the inorganic filler can have an average particle size of no greater than about 20 microns, such as not greater than about 15 microns, not greater than about 10 microns, not greater than about 5 microns, or not greater than about 3 microns. In yet other embodiments, the inorganic filler can be present in an amount of at least about 0.1 wt %, such as at least about 0.15 wt %, at least about 0.3 wt %, at least about 0.5 wt %, or at least about 1 wt % relative to the weight of the release layer. In further embodiments, the amount of the inorganic filler can be no greater than about 30 wt %, such as not greater than about 25 wt %, not greater than about 20 wt %, not greater than about 15 wt %, not greater than about 10 wt %, or not greater than about 5 wt % relative to the weight of the release layer.

Although not illustrated in FIG. 1, the release liner 100 can further include other ingredients. For example, the release liner can further include an additional release agent, a softener, a plasticizer, UV-absorbent, a flame retardant, or a colorant.

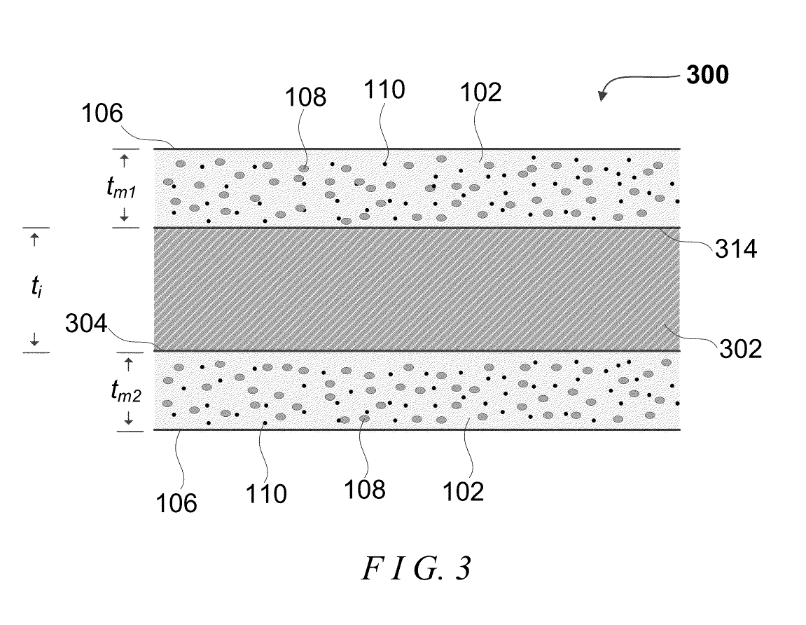

FIG. 2 illustrates a cross-sectional view of another exemplary multi-layered release liner 200. The release liner 200 can include a core layer comprising a polymer matrix 202. The polymer matrix 202 can have major surfaces 204 and 214. Further, the multi-layered release liner 200 can include a first release layer overlying major surface 204, and a second release layer overlying major surface 214. The first and second release layer can include elements, formulations, dimensions, and properties as discussed for the release layer in FIG. 1. Thus, the first and second release layer overlying major surfaces 204 and 214 can include a thermoplastic polymer matrix 102 including organic particulates 108 dispersed therein, and optionally an inorganic filler 110 dispersed therein. The outer surfaces 106 of the release liner 200 can have the same surface properties, such as texture and surface roughness Sₐ discussed for the major surfaces in FIG. 1.

The polymer matrix 202 can include a melt-processible polymer. In one embodiment, the polymer matrix 202 can include a non-fluorinated polymer. The non-fluorinated polymer can include a polyamide (PA), a polyethylene, a poly(ethylene terephthalate) (PET), and any combination thereof. In another embodiment, the polymer matrix 202 can include a fluoropolymer. The fluoropolymer can be the same as in element 102 or different. The fluoropolymer can be present in the same amount or different as in element 102. In yet another embodiment, the polymer matrix 202 can include a mixture of a fluoropolymer and a non-fluorinated polymer.

In embodiments, where polymer matrix 202 includes a non-fluorinated polymer and a fluoropolymer, the fluoropolymer and the non-fluorinated polymer can have a weight ratio of at least about 5:70, such as at least about 10:70, at least about 15:70, or at least about 20:70. In yet another embodiment, the weight ratio of fluoropolymer and the non-fluorinated polymer is not greater than about 30:60, such as not greater than about 30:65, or not greater than about 30:70.

The polymer matrix 202 can further include an organic particulate phase comprising organic particles 208. The organic particles can be the same as organic particles 108 described in FIG. 1. Alternatively, organic particles 208 can be differ from organic particles 108 in composition or dimension. For example, organic particles 208 can have a different average particle size than organic particles 108. Yet, organic particles 208 can have an average particles size within the ranges described for organic particles 108. In another embodiment, the weight ratio between the organic particulate phase comprising organic particles 208 and the polymer comprising polymer matrix 202 can be different than the analogous weight ratio for the release layer described in FIG. 1. For example, as illustrated in FIG. 2, the weight ratio between particles 208 and polymer matrix 202 can be smaller than the weight ratio of particles 108 and the polymer matrix 102. Alternatively (not illustrated in FIG. 2), it is contemplated that the weight ratio between particles 208 and polymer matrix 202 can be the same or greater than the weight ratio of particles 108 and the polymer matrix 102.

The multi-layered release liner 200 can further include an inorganic filler 210 dispersed in the polymer matrix 202. In embodiments, the inorganic filler 210 can be the same as the inorganic filler 110 described in FIG. 1. In other embodiments, the inorganic filler 210 can differ in composition, structure, dimension, or function from the inorganic filler 110. For example, filler 210 can be present in a different weight percentage in polymer matrix 202 than inorganic filler 110 in matrix 102.

Turning to the layer thicknesses of the multi-layered release liner 200. The first and second release layer overlying major surfaces 204 and 214 can have a thickness tₘ₂ and tₘ₁, respectively. The central layer comprising polymer matrix 202 can have a thickness t_{c}. In embodiments, the sum of tₘ₁, tₘ₂, and t_{c} can fall in the same range as discussed for tₛ in FIG. 1. In embodiments, tₘ₁, tₘ₂, and t_{c} can each individually have a thickness of at least about 1 micron, such as at least about 2 microns, at least about 5 microns, or at least about 8 microns. In another embodiment, tₘ₁, tₘ₂, and t_{c} can each individually have a thickness of not greater than about 400 microns, not greater than about 350 microns, not greater than about 300 microns, not greater than about 250 microns, not greater than about 200 microns, not greater than about 150 microns, not greater than about 100 microns, not greater than about 80 microns, or not greater than about 50 microns.

FIG. 3 illustrates a cross-sectional view of another exemplary multi-layered release liner 300. The release liner 300 can include a core layer comprising a polymer matrix 302. The polymer matrix 302 can have major surfaces 304 and 314. Further, the multi-layered release liner 200 can include a first release layer overlying major surface 304, and a second release layer overlying major surface 314. The first and second release layer can include elements, formulations, dimensions, and properties as discussed for the release layer in FIG. 1. Thus, the first and second release layer overlying major surfaces 304 and 314 can include a thermoplastic polymer matrix 102 including organic particulates 108 dispersed therein, and optionally an inorganic filler 110 dispersed therein. The outer surfaces 106 of the release liner 300 can have the same surface properties, such as texture and surface roughness Sₐ as discussed for the major surfaces in FIG. 1.

As illustrated in FIG. 3, the polymer matrix 302 in release liner 300 can be an unfilled polymer matrix 302. The polymer matrix 202 can include a melt-processible polymer. In one embodiment, the polymer matrix 302 can include a non-fluorinated polymer. The non-fluorinated polymer can include a polyamide (PA), a polyethylene, a poly(ethylene terephthalate) (PET), and any combination thereof. In another embodiment, the polymer matrix 302 consists essentially of a non-fluorinated polymer. In one particular embodiment, the polymer matrix 302 consists essentially of a polyamide.

The layer thicknesses of the multi-layered release liner 300 can be analogous to the layer thicknesses in release liner 200 of FIG. 2. The first and second release layer overlying major surfaces 304 and 314 can have a thickness tₘ₂ and tₘ₁, respectively. The intermediate layer comprising polymer matrix 302 can have a thickness tᵢ. In embodiments, the sum of tₘ₁, tₘ₂, and tᵢ can fall in the same range as discussed for tₛ in FIG. 1. In embodiments, tₘ₁, tₘ₂, and tᵢ can each individually have a thickness of at least about 1 micron, such as at least about 2 microns, at least about 5 microns, or at least about 8 microns. In another embodiment, tₘ₁, tₘ₂, and t_{c} can each individually have a thickness of not greater than about 400 microns, not greater than about 350 microns, not greater than about 300 microns, not greater than about 250 microns, not greater than about 200 microns, not greater than about 150 microns, not greater than about 100 microns, not greater than about 80 microns, or not greater than about 50 microns.

Turning to the method of molding an article. The method can include providing a mold assembly. The mold assembly can have an internal surface defining at least a portion of a cavity. The method can further include disposing a molding material into the cavity. The molding article can be disposed such that a release liner is positioned between the internal surface of the mold assembly and the molding material. The release liner can comprising the same structural, dimensional, and functional features as discussed for release liners illustrated herein and in FIGS. 1 through 3. The method can further include curing the molding material to form a shaped article. In one embodiment, the shape article includes a body part of a vehicle. In a particular embodiment, the body part includes the body part of an airplane.

### EXAMPLES

Several formulations were prepared from ETFE or ECTFE and micronized PTFE by melt mixing the quantities described in table 1. Titanium dioxide or glass beads were used as filler.

The components were mixed with a twin screw extruder to obtain a uniform blend. The resulted compounds were converted into a film using a 14″ monolayer die mounted with a 1″¼ diameter extruder. Surface roughness Sₐ were obtained using a Micro Measure 3D Surface Profilometer.

TABLE 1

| | | | Micronized | Micronized | | |
|---|---|---|---|---|---|---|
| | | | PTFE mean | PTFE mean | | |
| | | | particle size | particle size | | Surface |
| | ETFE | TiO2 | 12-24 μm | 3 μm | ECTFE | Roughness Sₐ |
| Formulation | (wt %) | (wt %) | (wt %) | (wt %) | (wt %) | (microns) |
| Reference 1 | 100 | 0 | 0 | 0 | 0 | 0.17 |
| Reference 2 | 0 | 0 | 0 | 0 | 100 | 0.36 |
| Sample 1 | 95 | 0 | 5 | 0 | 0 | 0.38 |
| Sample 2 | 90 | 0 | 10 | 0 | 0 | 0.87 |
| Sample 3 | 91.8 | 2 | 6.2 | 0 | 0 | 0.29 |
| Sample 4 | 87.6 | 2 | 10.4 | 0 | 0 | 0.28 |
| Sample 5 | 83.5 | 2 | 14.5 | 0 | 0 | 0.52 |
| Sample 6 | 91.8 | 2 | 3.1 | 3.1 | 0 | 0.24 |
| Sample 7 | 87.6 | 2 | 5.2 | 5.2 | 0 | 0.24 |
| Sample 8 | 83.5 | 2 | 7.3 | 7.3 | 0 | 0.30 |
| Sample 9 | 98 | 0 | 2 | 0 | 0 | 0.33 |
| Sample 10 | 96 | 0 | 4 | 0 | 0 | 0.38 |
| Sample 11 | 94 | 0 | 6 | 0 | 0 | 0.42 |
| Sample 12 | 92 | 0 | 8 | 0 | 0 | 0.87 |

As shown in Table 1, varying amount of micronized PTFE particles and PTFE particle size result in a spectrum of surface roughness Sₐ ranging between 0.17 and 0.87 microns. Accordingly, one of skill in the technology can adjust the formulations to obtain release liner or layers for release liners to having surface properties that achieve desired release properties.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The term “averaged,” when referring to a value, is intended to mean an average, a geometric mean, or a median value.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A release liner comprising:
at least one release layer, the release layer comprising a thermoplastic polymer matrix and an organic particulate phase in the thermoplastic polymer matrix.

2. A mold assembly comprising
a cavity for receiving a workpiece; and
a release liner disposed in the cavity, the release liner comprising at least one release layer, the release layer comprising a thermoplastic polymer matrix and an organic particulate phase in the thermoplastic polymer matrix.

3. The release liner according to claim 1, wherein the thermoplastic polymer matrix comprises a fluoropolymer.

4. The release liner according to claim 3, wherein the fluoropolymer is selected from the group consisting of poly(ethylene-tetrafluoroethylene) (ETFE), tetrafluoroethylene-perfluoropropylene (FEP), perfluoroalkoxy (PFA), polyethylenechlorotrifluoroethylene (ECTFE), polyvinylidene fluoride (PVDF), and any combination thereof.

5. (canceled)

6. (canceled)

7. The release liner according to claim 3, wherein the fluoropolymer comprises poly(ethylene-tetrafluoroethylene) (ETFE).

8. (canceled)

9. The release liner according to claim 1, wherein the thermoplastic polymer matrix has a melting point of at least about 195° C.

10. The release liner according to claim 9, wherein the melting point is not greater than about 330° C.

11. The release liner according to claim 1, wherein the organic particulate phase comprises a non-melt-processible polymer.

12. The release liner according to claim 11, wherein the non-melt-processible polymer includes polytetrafluoroethylene (PTFE).

13. (canceled)

14. The release liner according to claim 12, wherein the PTFE is micronized PTFE.

15. The release liner according to claim 1, wherein the organic particulate phase has an average particle size of at least about 1 micron.

16. The release liner or the mold assembly according to claim 15, wherein the average particle size is not greater than about 250 microns.

17. The release liner according to claim 1, wherein the organic particulate phase and the thermoplastic polymer matrix have a weight ratio of at least about 2:95.

18. The release liner according to claim 17, wherein the weight ratio is not greater than about 20:78.

19. The release liner according to claim 1, wherein the organic particulate phase includes a plurality of particles dispersed in the thermoplastic polymer matrix, and wherein the plurality of particles are distributed in a bimodal distribution.

20. (canceled)

21. The release liner according to claim 19, wherein a first mode of the bimodal distribution has an average particle size maximum of at least about 1 micron.

22. The release liner according to claim 21, wherein a second mode of the bimodal distribution has an average particle size maximum of at least about 10 micron.

23-111. (canceled)

112. The mold assembly according to claim 2, wherein the thermoplastic polymer matrix comprises a fluoropolymer selected from the group consisting of poly(ethylene-tetrafluoroethylene) (ETFE), tetrafluoroethylene-perfluoropropylene (FEP), perfluoroalkoxy (PFA), polyethylenechlorotrifluoroethylene (ECTFE), polyvinylidene fluoride (PVDF), and any combination thereof.

113. The mold assembly according to claim 2, wherein the organic particulate phase includes a plurality of particles dispersed in the thermoplastic polymer matrix, and wherein the plurality of particles are distributed in a bimodal distribution.

114. The mold assembly according to claim 113, wherein a first mode of the bimodal distribution has an average particle size maximum of at least about 1 micron, and wherein a second mode of the bimodal distribution has an average particle size maximum of at least about 10 micron.
